(19) United States
(12) Patent Application Publication
(10) Pub. No.: US 2026/0252215 A1
(43) Pub. Date: Aug. 27, 2026

(54) DISPLAYING TIMESTAMPS FOR VIEWS OF CONTENT COLLECTIONS

(71) Applicant: Snap Inc., Santa Monica, CA (US)

(72) Inventor: Suraya Shivji, New York, NY (US)

(21) Appl. No.: 19/065,871

(22) Filed: Feb. 27, 2025

(51) Int. Cl. G06F 3/0484; G06F 21/10

(52) U.S. Cl. CPC G06F 3/0484; G06F 21/1015

(57) ABSTRACT

Aspects of the present disclosure involve a system comprising a computer-readable storage medium storing a program and method for displaying timestamps for views of content collections. The program and method provide for providing access to a content collection of a first user of an application, the first user being associated with a first device; storing a respective timestamp for each view of the content collection by second users of the application, the second users being associated with second devices; receiving, from the first device, a request to display an indication of each view of the content collection by the second users; determining whether the first user has a paid subscription with respect to the application; and providing, on the first device and upon determining that the first user has a paid subscription, display of the views with timestamp information based on the respective timestamp for each view.

### TECHNICAL FIELD

The present disclosure relates generally to a system configured to display timestamps for views of content collections.

### BACKGROUND

Systems such as messaging systems provide for the exchange of media content between users. For example, such systems allow for a user to publish media content (e.g., text, video, pictures) for viewing by other users.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 is an interaction diagram illustrating a process for displaying timestamps for views of content collections, in accordance with some examples.

FIG. 6 illustrates a content collection overview interface for displaying viewing data of a content collection according to a first format, in accordance with some examples.

FIG. 7 illustrates a paid subscriber interface for accessing exclusive features available to paid subscribers and unavailable to non-paid subscribers, in accordance with some examples.

FIG. 8 illustrates a content collection overview interface for displaying viewing data of a content collection according to a second format, in accordance with some examples.

FIG. 9 illustrates a subscription enrollment interface for subscribing to the exclusive features available to paid subscribers, in accordance with some examples.

FIG. 10 is a flowchart illustrating a process for providing a template for media content generation, in accordance with some examples.

FIG. 11 is a diagrammatic representation of a machine in the form of a computer system within which a set of instructions may be executed to cause the machine to perform any one or more of the methodologies discussed herein, according to some examples.

FIG. 12 is a block diagram showing a software architecture within which examples may be implemented.

### DETAILED DESCRIPTION

Systems such as messaging systems typically allow a first user at a first device to publish a content collection (e.g., a collection of media content items with image, video and/or audio data) for viewing by second users of the system. As described herein, the system provides for displaying an indication of the views by the second users, together with respective timestamps for each view.

The disclosed embodiments relate to a system which displays timestamps of when the second users at their respective second devices viewed a content collection posted by the first user. Each time the content collection is viewed by one of the second users, the system stores a timestamp of when the content collection was viewed together with the user ID of that second user. When the first user requests to see the views of the content collection, the system determines if the user is a paid subscriber with respect to the system. If the first user is a paid subscriber, the first device presents the chronology of views by the second users together with the respective timestamps of the views. If the first user is not a paid subscriber, the first device presents the chronology of views by the second users, omits the respective timestamps of the views, and upsells the first user to become a paid subscriber.

By virtue of displaying timestamps in this manner, the system provides for presenting additional viewing data (e.g., timestamps of content collection views) for paid subscribers who publish content collections. The system increases the likelihood for users to become paid subscribers, by providing non-subscribers with a compelling feature to subscribe. Moreover, the system provides existing paid subscribers with an additional feature that provides value to the subscription.

### NETWORKED COMPUTING ENVIRONMENT

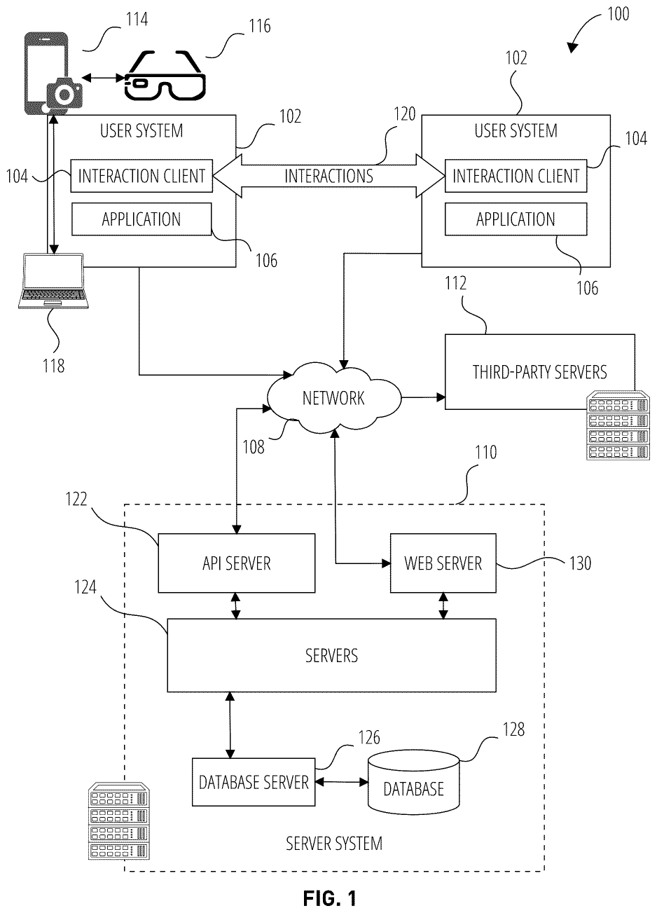

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

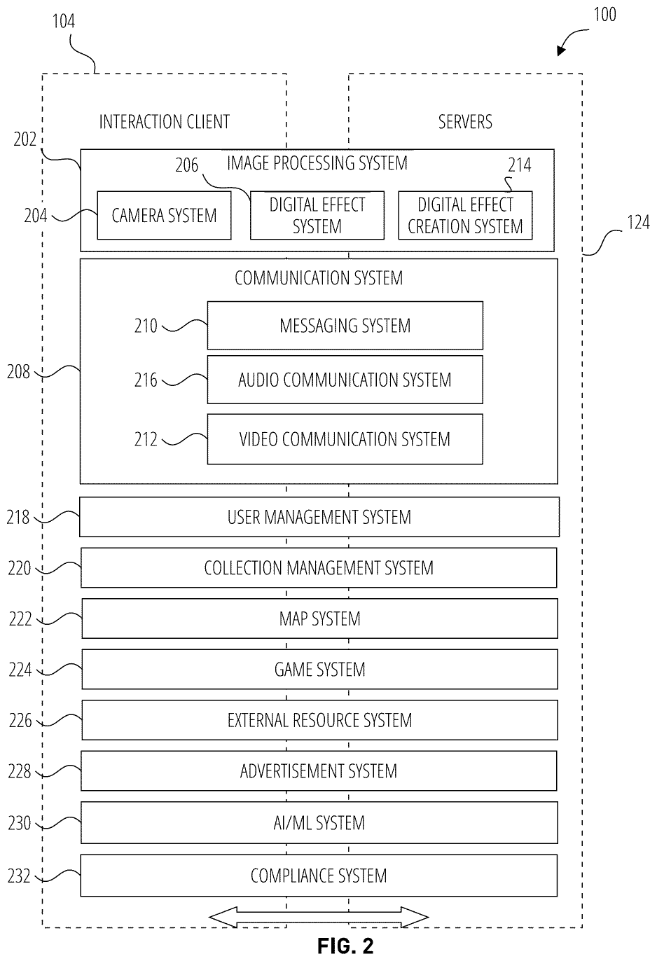

The servers 124 host multiple systems and subsystems, described below with reference to FIG. 2.

### EXTERNAL RESOURCES AND LINKED APPLICATIONS

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### SYSTEM ARCHITECTURE

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### DATA ARCHITECTURE

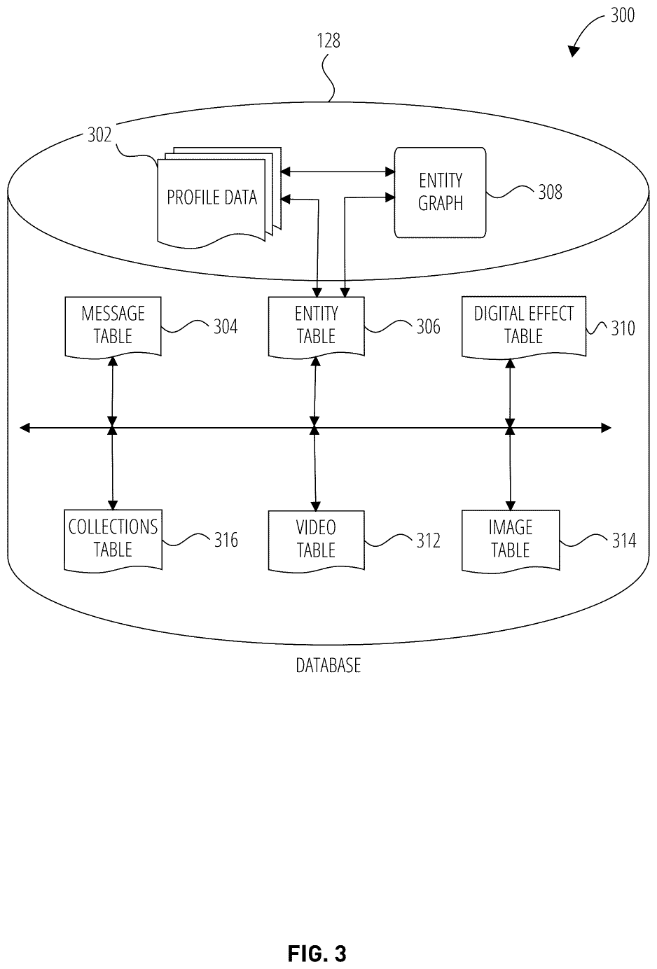

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

In example embodiments, the collections table 316 further stores historical viewing data for each of the content collections. For example, each time a content collection is viewed, the collections table 316 stores a record of which user viewed the content collection (e.g., a User ID of the viewing user) and a timestamp of when the content collection was viewed (e.g., a time when the viewing user selected to view the content collection).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

### DATA COMMUNICATIONS ARCHITECTURE

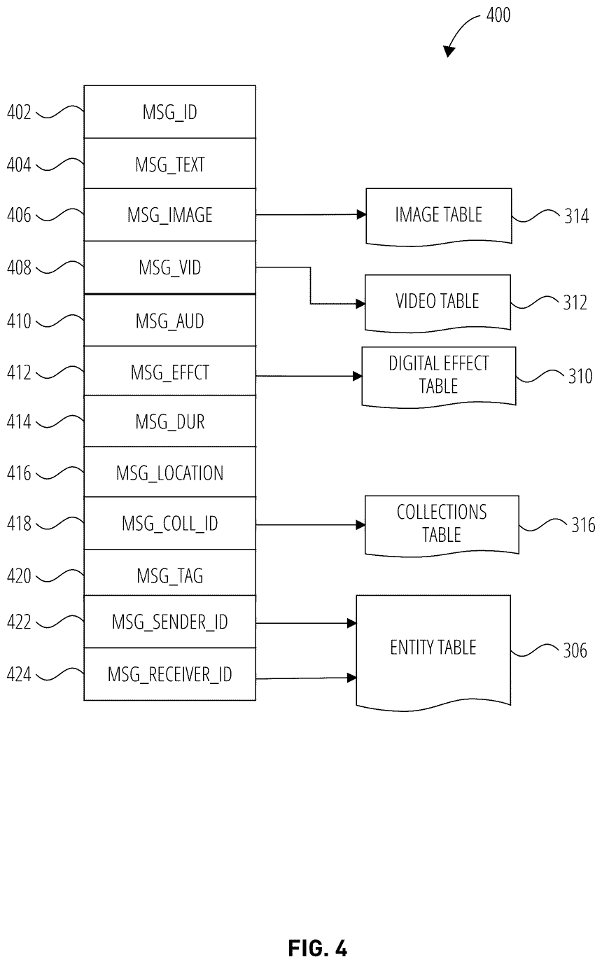

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

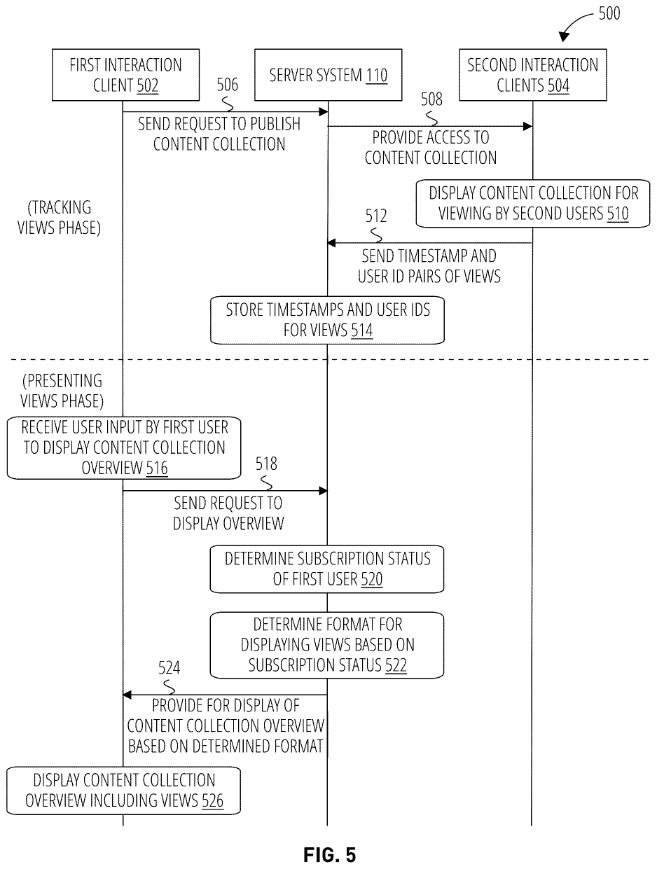

FIG. 5 is an interaction diagram illustrating a process 500 for displaying timestamps for views of content collections, in accordance with some examples. For explanatory purposes, the process 500 is primarily described herein with reference to the interaction client 104 (e.g., corresponding to the first interaction client 502 and the second interaction clients 504) and to the server system 110 of FIG. 1. However, one or more blocks (or operations) of the process 500 may be performed by one or more other components, and/or by other suitable devices. Further for explanatory purposes, the blocks (or operations) of the process 500 are described herein as occurring in serial, or linearly. However, multiple blocks (or operations) of the process 500 may occur in parallel or concurrently. In addition, the blocks (or operations) of the process 500 need not be performed in the order shown and/or one or more blocks (or operations) of the process 500 need not be performed and/or can be replaced by other operations. The process 500 may be terminated when its operations are completed. In addition, the process 500 may correspond to a method, a procedure, an algorithm, etc.

In example embodiments, each of the first interaction client 502 and the second interaction clients 504 correspond to respective instances of the interaction client 104, with the first interaction client 502 running on a first device (e.g., a first user system 102) and the second interaction clients 504 running on respective second devices (e.g., second user systems 102). The first interaction client 502 is associated with a respective first user, and the second interaction clients 504 are associated with respective second users of the digital interaction system 100. For example, the first user is associated with a respective first user account of the server system 110, and each of the second users is associated with a respective second user account of the server system 110. As noted above, the first and second users are identified by the server system 110 based on unique identifiers (e.g., a messaging system identifier, email address and/or a device identifier) associated with the respective user accounts for the first and second users.

As described herein, the digital interaction system 100 provides for displaying timestamps of when second users at their respective second interaction clients 504 viewed a content collection posted by a first user at the first interaction client 502. Each time the content collection is viewed by one of the second users, the server system 110 stores a timestamp of when the content collection was viewed together with the user ID of that second user. When the first user requests to see the views of the content collection, the server system 110 determines if the user is a paid subscriber with respect to the application (e.g., the interaction client 104). If the first user is a paid subscriber, the first interaction client 502 presents the chronology of views by the second users together with the respective timestamps of the views. If the first user is not a paid subscriber, the first interaction client 502 presents the chronology of views by the second users, omits the respective timestamps of the views, and upsells the first user to become a paid subscriber.

In the example of FIG. 5, operations 506-514 correspond to a first phase (e.g., a “tracking views phase”) and operations 516-526 correspond to a second phase (e.g., a “presenting views phase”). As such, FIG. 5 includes a dashed line separating the first phase and the second phase for illustrative purposes.

During the tracking views phase, the server system 110 provides the second users with access to the content collection of the first user. The server system 110 tracks views of the content collection by the second users at their respective second interaction clients 504, and stores a respective timestamp and user identification for each view. During the presenting views phase, the server system 110 presents the chronology of views by the second users to the first user at the first interaction client 502. If the first user is a paid subscriber, the server system 110 also presents the respective timestamps of the views on the first interaction client 502. Otherwise, the timestamps are omitted (e.g., obscured) from display on the first interaction client 502.

At operation 506, the first interaction client 502 sends a request to publish a content collection (e.g., a Story) to the server system 110. As noted above, a content collection is a collection of messages and associated image, video, or audio data, which are compiled into a collection. The digital interaction system 100 provides for the first user to publish (e.g., send, broadcast) a content collection in different manners. For example, the first interaction client 502 displays interface elements to publish the content collection as one of: a private content collection which only permits the first user to add content and which is viewable by user-selected contacts; a shared content collection which permits user-selected contacts to add content and which is viewable by user-selected contacts; a friends content collection which only permits the first user to add content and which is viewable by all contacts (e.g., direct contacts) of the first user; and a public content collection which only permits the first user to add content and which is viewable by the public.

At operation 508, the server system 110 provides the second interaction clients 504 with access to the content collection. In example embodiments, the server system 110 provides for display of interfaces (e.g., a content feeds interface) at the second interaction clients 504. The content feeds interface provides for viewing content collections from different types of content feeds. For example, the content feeds interface includes a contacts content feed, a subscription content feed and a suggested content feed.

For each of the second users, the contacts content feed includes available content collections corresponding to contacts (e.g., friends) of the second user. Each content collection is represented by a respective icon (e.g., thumbnail) which is user-selectable to view the respective content collection. The subscription content feed includes user-selectable content submitted by entities (e.g., influencers, companies, and the like) to which the second user subscribes with respect to the digital interaction system 100. Moreover, the suggested content feed includes user-selectable content otherwise suggested to the user (e.g., as determined by the interaction system 100).

At block 510, the second interaction clients 504 display the content collection for viewing by the second users. For example, one or more of the second users at the second interaction clients 504 may have selected to view the content collection (e.g., via the contacts content feed in the content feeds interface). In response, the second interaction clients 504 in conjunction with the server system 110 display the content collection for viewing by the second users. Each view has a corresponding timestamp for when viewing started (e.g., when the second user started viewing the content collection), and a user ID identifying which one of the second users viewed content collection at that time.

Thus, at operation 512, the second interaction clients 504 send timestamp and user ID pairs of the views by the second users to the server system 110. At block 514, the server system 110 stores the timestamp and user ID pairs (e.g., in the collections table 316) for each view by the second users. It is noted that operations 510-514 may be repeated for every view by a second user at one of the respective second interaction clients 504. In this way, the collections table 316 is continually updated as second users view the content collection, and it is possible to create a chronology of views by the second users of the content collection.

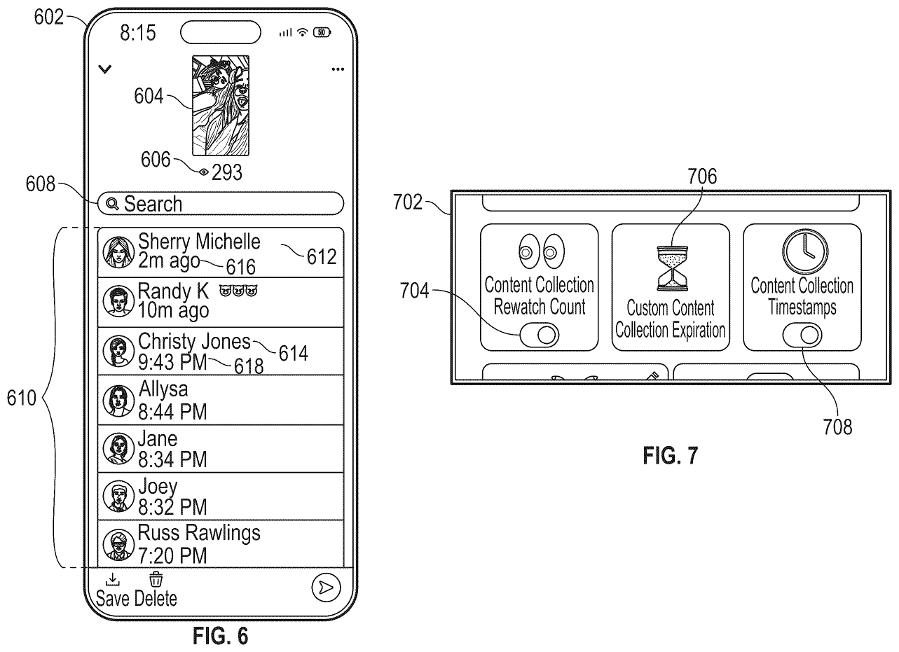

As noted above, operations 516-526 relate to displaying, on the first interaction client 502, the chronology of views of the content collection by the second users. At block 516, the first interaction client 502 receives user input by the first user to display a content collection overview (e.g., discussed further below with respect to FIG. 6). In example embodiments, the user input is received via a personal profile interface displayed by the first interaction client 502. The personal profile interface presents information about the first user, such as user name, contact information and/or friends (e.g., contacts) of the first user. Moreover, the personal profile interface includes user-selectable options for updating account settings corresponding to the personal profile, such as personal avatar(s). In addition, the personal profile interface includes a list of content collections of the first user (e.g., appearing under a “My Stories” header), each content collection in the list being user-selectable to present a respective overview of the content collection.

In response to the user input received at block 516, the first interaction client 502 sends a request to display the content collections overview to the server system 110 (operation 518). In response to the request, the server system 110 determines a subscription status of the first user (block 520).

In example embodiments, the digital interaction system 100 provides selected users with exclusive features that are not available to all users of the digital interaction system 100. For example, the selected users are those users who opt into a subscription plan. The subscription plan corresponds to a paid plan (e.g., a monthly subscription, a yearly subscription, etc.) that provides access to the exclusive features within the digital interaction system 100. In example embodiments, one of the exclusive features available to selected users (e.g., paid subscribers) is the viewing of timestamps when displaying views of a content collection.

Thus, at block 520, the server system 110 determines if the first user has opted into the subscription plan (e.g., as a paid subscriber), or if the first user has not opted into the subscription plan. The server system 110 then determines a format for displaying the views based on a subscription status of the first user (block 522). In example embodiments, the server system 110 provides for presenting a first format for subscribers, and a second format for non-subscribers.

As discussed further below with respect to FIG. 6, the first format presents a list of the second users who viewed the content collection, together with timestamp data for each view. The list is presented in chronological order (e.g., most recent at the top) based on the stored timestamps. For each stored timestamp-user ID pair (e.g., where the user ID represents a respective second user), the server system 110 calculates the time difference between the stored timestamp and the current time.

If the time difference is 0-1 minutes, meaning the second user viewed the story less 1 minute ago, the first interaction client 502 displays the timestamp as “Just now.” If the time difference is between 1-30 minutes, the first interaction client 502 displays the timestamp as “[x]m ago,” where x is the time difference. On the other hand, if the time difference is greater than 30 minutes, the first interaction client 502 displays the literal timestamp of the view. In example embodiments, the timestamp is formatted to be consistent with how time is generally displayed on the first interaction client 502 (e.g., military time). Moreover, the timestamp is displayed in the time zone of the first interaction client 502.

As discussed further below with respect to FIG. 7, the second format (e.g., for non-subscribers) presents a chronological list of the second users who viewed the content collection, while omitting the timestamp for each view. The list is presented in chronological order (e.g., most recent at the top) based on the stored timestamps. In example embodiments, the second format also includes an interface element which upsells the first user opt into the subscription plan.

Thus, at operation 524, the server system 110 provides for display of the content collection overview (e.g., including the second user views) based on the determined first or second format. At block 526, the first interaction client 502 displays the content collection overview, including the views of the content collection, to the first user according to the determined first or second format.

Thus, the digital interaction system 100 provides for displaying timestamps of when second users at their respective second interaction clients 504 viewed a content collection posted by a first user at the first interaction client 502. Each time the content collection is viewed by one of the second users, the server system 110 stores a timestamp of when the content collection was viewed together with the user ID of that second user. When the first user requests to see the views of the content collection, the server system 110 determines if the user is a paid subscriber with respect to the application (e.g., the interaction client 104). If the first user is a paid subscriber, the first interaction client 502 presents the chronology of views by the second users together with the respective timestamps of the views. If the first user is not a paid subscriber, the first interaction client 502 presents the chronology of views by the second users, omits the respective timestamps of the views, and upsells the first user to become a paid subscriber.

By virtue of the foregoing, the digital interaction system 100 provides for presenting additional viewing data (e.g., timestamps of content collection views) for paid subscribers who publish content collections. The digital interaction system 100 increases the likelihood for users to become paid subscribers, by providing non-subscribers with a compelling feature to subscribe. Moreover, the digital interaction system 100 provides existing paid subscribers with an additional feature that provides value to the subscription.

FIG. 6 illustrates a content collection overview interface 602 for displaying viewing data of a content collection according to a first format, in accordance with some examples. As noted above, the first interaction client 502 may display the content collection overview interface 602 in the first format for subscribers (e.g., as opposed to a second format for non-subscribers). In the example of FIG. 6, the content collection overview interface 602 includes a thumbnail 604, a view count 606, a search bar 608, and a list of viewers 610. The list of viewers 610 includes second users such as second users 612-614 with corresponding timestamps 616-618.

In example embodiments, the content collection overview interface 602 is presented when the first user is a paid subscriber, in response to user input received within a personal profile interface displayed by the first interaction client 502. As noted above, the personal profile interface presents information about the first user, such as user name, contact information and/or friends (e.g., contacts) of the first user. The personal profile further interface includes user-selectable options for updating account settings corresponding to the personal profile, such as personal avatar(s).

In addition, the personal profile interface includes a paid subscriber element. The paid subscriber element is user-selectable redirect to a paid subscriber interface, which provides the first user with accesses to exclusive features available to paid subscribers and unavailable to non-paid subscribers. The paid subscriber interface is described in further detail below with respect to FIG. 7.

Moreover, the personal profile interface includes a list of content collections of the first user (e.g., appearing under a “My Stories” header), each content collection in the list being user-selectable to present a respective content collection overview. The content collection overview interface 602 illustrates an example of the first user having selected to display a particular content collection overview from the list of content collections.

The thumbnail 604 includes a representative image or a representative video snippet of the content collection. For example, the server system 110 is configured to automatically identify an image or video snippet that is representative of the content collection, for use as the thumbnail 604. In addition, the view count 606 indicates a total number of views for the content collection. For example, the server system 110 stores and maintains the view count 606 within the collections table 316 of the database 128.

In example embodiments, the search bar 608 allows the first user to input text for searching for a particular second user within the list of viewers 610. The first interaction client 502 (e.g., in conjunction with the server system 110) provides for predictive text in searching the list of viewers 610, for completion of partially input text within the search bar 608.

As noted above, the content collection overview interface 602 of FIG. 6 is surfaced when the first user is a paid subscriber. The first format presents the list of viewers 610 (e.g., the second users who viewed the content collection) together with the timestamp for each view. The list of viewers 610 is presented in chronological order (e.g., most recent at the top) based on the timestamps in the collections table 316.

For each stored timestamp-user ID pair (e.g., where the user ID represents a respective second user), the server system 110 calculates the time difference between the stored timestamp and the current time. If the time difference is 0-1 minutes, meaning the second user viewed the story less 1 minute ago, the first interaction client 502 displays the timestamp as “Just now” (not shown in FIG. 6). If the time difference is between 1-30 minutes, the first interaction client 502 displays the timestamp as “[x]m ago,” where x is the time difference (e.g., see the second user 612 and corresponding timestamp 616). On the other hand, if the time difference is greater than 30 minutes, the first interaction client 502 displays the literal timestamp of the view (e.g., see the second user 614 and corresponding timestamp 618). In example embodiments, the timestamp is formatted to be consistent with how time is generally displayed on the first interaction client 502 (e.g., military time). Moreover, the timestamp is displayed in the time zone of the first interaction client 502.

FIG. 7 illustrates a paid subscriber interface 702 for accessing exclusive features available to paid subscribers and unavailable to non-paid subscribers, in accordance with some examples. In the example of FIG. 7, the paid subscriber interface 702 is a partial view of a complete paid subscriber interface, and includes a rewatch count toggle 704, a custom expiration 706 and a timestamp toggle 708. It is noted that the complete paid subscriber interface may include access to additional exclusive features which are not shown in the paid subscriber interface 702.

In example embodiments, the rewatch count toggle 704 is user-selectable to enable or disable a rewatch count. While not shown in the example of FIG. 6, the rewatch count is presented within the content collection overview interface. The rewatch count shows how many viewers have rewatched a particular content collection.

In example embodiments, the custom expiration 706 provides the ability for paid subscribers (e.g., the first subscriber) to set a specific timeframe for how long their personal content collections will last. The custom expiration 706 allows the first user to choose an expiration time other than a default expiration time (e.g., 24 hours), such as 1 hour, 6 hours, 12 hours, two days, a week, and the like.

In example embodiments, the timestamp toggle 708 is user-selectable to enable or disable the viewing of timestamps. Thus, with respect to FIG. 6 as described above, when the first user is a paid subscriber, the first user can select to include timestamps (e.g., by enabling the timestamp toggle 708) within the list of viewers 610, or to omit timestamps (e.g., by disabling the timestamp toggle 708) within the list of viewers 610.

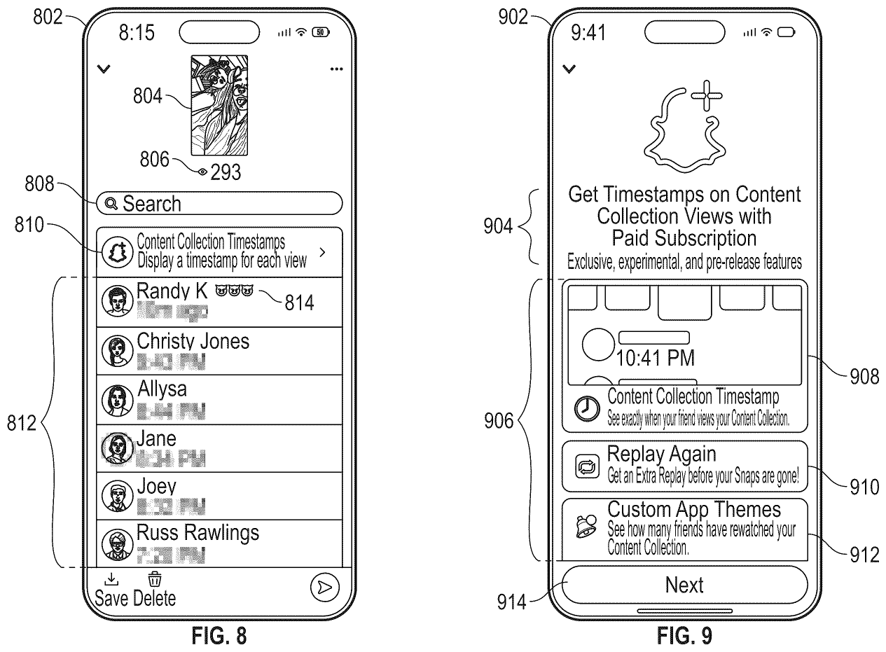

FIG. 8 illustrates a content collection overview interface 802 for displaying viewing data of a content collection according to a second format, in accordance with some examples. As noted above, the first interaction client 502 may display the content collection overview interface 602 in the second format for non-subscribers (e.g., as opposed to a first format for subscribers). In the example of FIG. 8, the content collection overview interface 802 includes a thumbnail 804, a view count 806, a search bar 808, an upsell button 810 and a list of viewers 812. The list of viewers 812 includes second users, such as second user 814.

In example embodiments, the content collection overview interface 802 is presented when the first user is a non-subscriber, in response to user input received within a personal profile interface displayed by the first interaction client 502. As noted above, the personal profile interface presents information about the first user, such as user name, contact information and/or friends (e.g., contacts) of the first user. In addition, the personal profile interface includes user-selectable options for updating account settings corresponding to the personal profile, such as personal avatar(s).

Moreover, the personal profile interface includes a list of content collections of the first user (e.g., appearing under a “My Stories” header), each content collection in the list being user-selectable to present a respective content collection overview. The content collection overview interface 802 illustrates an example of the first user selecting to display a particular content collection overview from the list of content collections.

The thumbnail 804 includes a representative image or a representative video snippet of the content collection. For example, the server system 110 is configured to automatically identify an image or video snippet that is representative of the content collection, for use as the thumbnail 804. In addition, the view count 806 indicates a total number of views for the content collection. For example, the server system 110 stores and maintains the view count 806 within the collections table 318 of the database 128.

In example embodiments, the search bar 808 allows the first user to input text for searching for a particular second user within the list of viewers 812. The first interaction client 502 (e.g., in conjunction with the server system 110) provides for predictive text in searching the list of viewers 812, for completion of partially input text within the search bar 808.

As noted above, the content collection overview interface 802 of FIG. 8 corresponds to a second format which is surfaced when the first user is a non-subscriber. Thus, the content collection overview interface 802 presents the list of viewers 812 (e.g., those second viewers who viewed the content collection), while omitting (e.g., obscuring) the timestamp for each view. The list of viewers 812 is presented in chronological order (e.g., most recent at the top) based on the timestamps stored in the collections table 316 of the database 128.

As noted above, the second format also includes an interface element which upsells the first user to opt into the subscription plan. Thus, the content collection overview interface 802 includes an upsell button 810 which is user-selectable to upsell (e.g., prompt) the first user to purchase/opt into the subscription-based version of the interaction client 104. In example embodiments, the upsell button 810 is positioned above the list of viewers 812. In addition, the upsell button 810 includes a headline (e.g., “Content Collection Timestamps”) and a body (e.g., “Display a timestamp for each view”). In example embodiments, the server system 110 determines if the content collection has threshold number of views (e.g., 1 or more views), and only displays the upsell button 810 if the content collection meets the threshold. In response to user selection of the upsell button 810, the first interaction client 502 presents the subscription enrollment interface 902, which is discussed further below with respect to FIG. 9.

FIG. 9 illustrates a subscription enrollment interface 902 for subscribing to the exclusive features available to paid subscribers, in accordance with some examples. In the example of FIG. 9, the subscription enrollment interface 902 includes a headline 904, a list of features 906 (including a timestamp cell 908, a replay again cell 910 and a custom app themes cell 912), and a next button 914. It is noted that list of features 906 may include exclusive features in addition to features corresponding to cells 908-912.

As shown in the example of FIG. 9, the timestamp cell 908 is displayed different than (e.g., larger than) the cells 910-912. In example embodiments, display of the headline 904 and the differentiated display of the timestamp cell 908 is based on a determination by the server system 110 that the first user arrived at the subscription enrollment interface 902 via the upsell button 810 (as opposed to via respective upsell buttons for features corresponding to the cells 910-912).

In the example of FIG. 9, headline indicates to the first user to get timestamps on content collection views with a paid subscription. In addition, the timestamp cell 908 includes a cell emoji (e.g., a clock), a cell title (e.g., content collection timestamp), and a cell body (e.g., “see exactly when your friend views your content collection”). The next button 914 is user-selectable to surface additional interfaces (e.g., payment interfaces) for completing enrollment of the subscription.

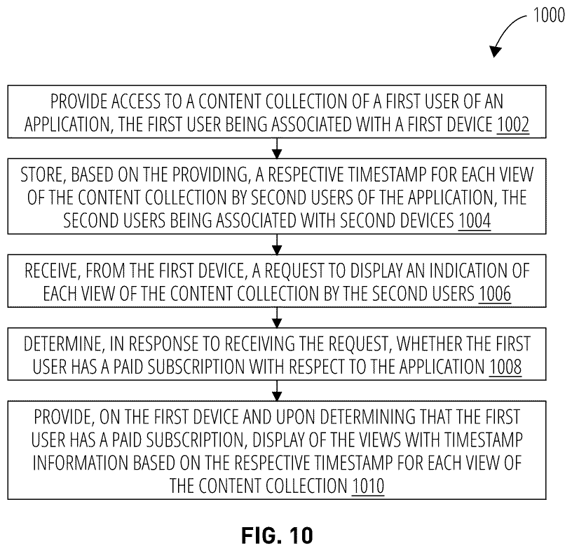

FIG. 10 is a flowchart illustrating a process 1000 for providing a template for media content generation, in accordance with some examples. For explanatory purposes, the process 1000 is primarily described herein with reference to the server system 110, the first interaction client 502 and the second interaction clients 504 of FIGS. 1 and 5. However, one or more blocks (or operations) of the process 1000 may be performed by one or more other components, and/or by other suitable devices. Further for explanatory purposes, the blocks (or operations) of the process 1000 are described herein as occurring in serial, or linearly. However, multiple blocks (or operations) of the process 1000 may occur in parallel or concurrently. In addition, the blocks (or operations) of the process 1000 need not be performed in the order shown and/or one or more blocks (or operations) of the process 1000 need not be performed and/or can be replaced by other operations. The process 1000 may be terminated when its operations are completed. In addition, the process 1000 may correspond to a method, a procedure, an algorithm, etc.

The server system 110 provides access to a content collection of a first user of an application, the first user being associated with the first interaction client 502 (block 1002). The server system 110 stores, based on the providing, a respective timestamp for each view of the content collection by second users of the application, the second users being associated with second interaction clients 504 (block 1004).

The server system 110 receives, from the first interaction client 502, a request to display an indication of each view of the content collection by the second users (block 1006). The server system 110 determines, in response to receiving the request, whether the first user has a paid subscription with respect to the application (block 1008).

The server system 110 provides, on the first interaction client 502 and upon determining that the first user has a paid subscription, display of the views with timestamp information based on the respective timestamp for each view of the content collection (block 1010). In example embodiments, the server system 110 provides, on the first interaction client 502, display of an interface element which is user-selectable to enable display of the timestamp information, and receives, via the interface element, user input selecting to enable display of the timestamp information. Providing display of the views with the timestamp information is based on receiving the first user input.

In example embodiments, providing display of the views with the timestamp information includes determining, for a first timestamp of the respective timestamps, an amount of time elapsed between the first timestamp and a current time, and providing, when the amount of time is below a first time threshold, display of the timestamp information of the first timestamp according to a first format.

In example embodiments, providing display of the views with the timestamp information further includes providing, when the amount of time meets the first time threshold, display of the timestamp information of the first timestamp according to a second format. Providing display of the views with the timestamp information further includes providing, when the amount of time is below a second time threshold which is less than the first time threshold, display of the timestamp information of the first timestamp according to a third format.

In example embodiments, the server system 110 provides, on the first interaction client 502 and upon determining that the first user does not have a paid subscription, display of the views without the timestamp information for each view of the content collection. In addition, the server system 110 provides, on the first interaction client 502, a user-selectable element for the first user to enroll for the paid subscription with respect to the application.

### MACHINE ARCHITECTURE

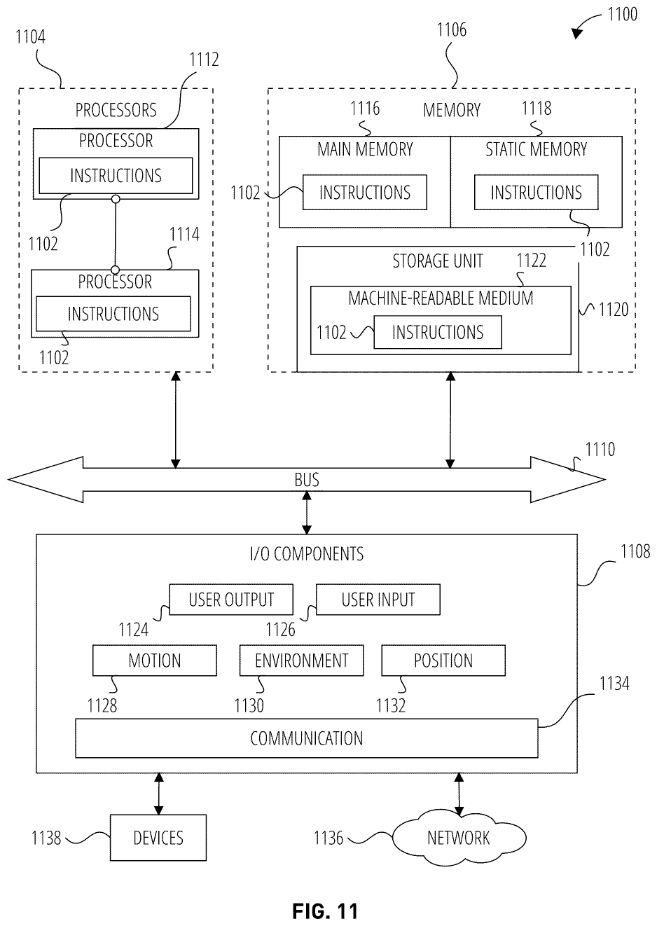

FIG. 11 is a diagrammatic representation of the machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. The machine 1100, for example, may comprise the user system 102 or any one of multiple server devices forming part of the server system 110. In some examples, the machine 1100 may also comprise both client and server systems, with certain operations of a particular method or algorithm being performed on the server-side and with certain operations of the method or algorithm being performed on the client-side.

The machine 1100 may include processors 1104 (e.g., the processor 1112 and the processor 1114), memory 1106, and input/output I/O components 1108, which may be configured to communicate with each other via a bus 1110.

The memory 1106 includes a main memory 1116, a static memory 1118, and a storage unit 1120, both accessible to the Processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the Processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1108 may include motion components 1128, environmental components 1130, or position components 1132, among a wide array of other components. The motion components 1128 include acceleration sensor components (e.g., accelerometer), gravitation sensor components, rotation sensor components (e.g., gyroscope).

The environmental components 1130 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1108 further include communication components 1134 operable to couple the machine 1100 to a Network 1136 or devices 1138 via respective coupling or connections. For example, the communication components 1134 may include a network interface component or another suitable device to interface with the Network 1136. In further examples, the communication components 1134 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1138 may be another machine or any of a wide variety of peripheral devices (e.g., a peripheral device coupled via a USB).

Moreover, the communication components 1134 may detect identifiers or include components operable to detect identifiers. For example, the communication components 1134 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph^{TM}, MaxiCode, PDF417, Ultra Code, UCC RSS-2D bar code, and other optical codes), or acoustic detection components (e.g., microphones to identify tagged audio signals). In addition, a variety of information may be derived via the communication components 1134, such as location via Internet Protocol (IP) geolocation, location via Wi-Fi® signal triangulation, location via detecting an NFC beacon signal that may indicate a particular location, and so forth.

The various memories (e.g., main memory 1116, static memory 1118, and memory of the Processors 1104) and storage unit 1120 may store one or more sets of instructions and data structures (e.g., software) embodying or used by any one or more of the methodologies or functions described herein. These instructions (e.g., the instructions 1102), when executed by Processors 1104, cause various operations to implement the disclosed examples.

The instructions 1102 may be transmitted or received over the Network 1136, using a transmission medium, via a network interface device (e.g., a network interface component included in the communication components 1134) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1138.

### SOFTWARE ARCHITECTURE

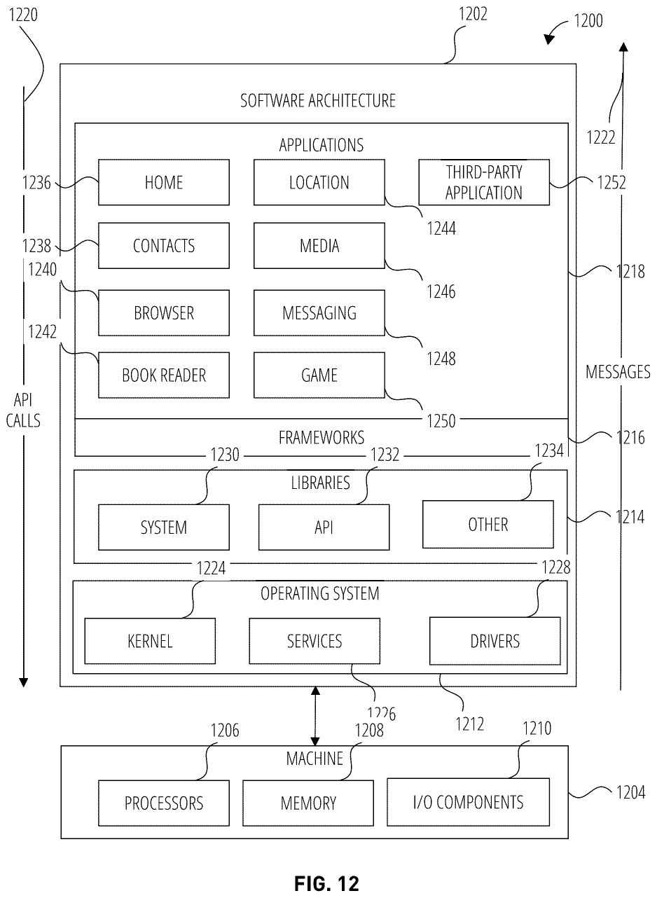

FIG. 12 is a block diagram 1200 illustrating a software architecture 1202, which can be installed on any one or more of the devices described herein. The software architecture 1202 is supported by hardware such as a machine 1204 that includes Processors 1206, memory 1208, and I/O components 1210. In this example, the software architecture 1202 can be conceptualized as a stack of layers, where each layer provides a particular functionality. The software architecture 1202 includes layers such as an operating system 1212, libraries 1214, frameworks 1216, and applications 1218. Operationally, the applications 1218 invoke API calls 1220 through the software stack and receive messages 1222 in response to the API calls 1220.

The operating system 1212 manages hardware resources and provides common services. The operating system 1212 includes, for example, a kernel 1224, services 1226, and drivers 1228. The kernel 1224 acts as an abstraction layer between the hardware and the other software layers. For example, the kernel 1224 provides memory management, processor management (e.g., scheduling), component management, networking, and security settings, among other functionalities. The services 1226 can provide other common services for the other software layers. The drivers 1228 are responsible for controlling or interfacing with the underlying hardware. For instance, the drivers 1228 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1214 provide a common low-level infrastructure used by the applications 1218. The libraries 1214 can include system libraries 1230 (e.g., C standard library) that provide functions such as memory allocation functions, string manipulation functions, mathematical functions, and the like. In addition, the libraries 1214 can include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1214 can also include a wide variety of other libraries 1234 to provide many other APIs to the applications 1218.

The frameworks 1216 provide a common high-level infrastructure that is used by the applications 1218. For example, the frameworks 1216 provide various graphical user interface (GUI) functions, high-level resource management, and high-level location services. The frameworks 1216 can provide a broad spectrum of other APIs that can be used by the applications 1218, some of which may be specific to a particular operating system or platform.

In an example, the applications 1218 may include a home application 1236, a contacts application 1238, a browser application 1240, a book reader application 1242, a location application 1244, a media application 1246, a messaging application 1248, a game application 1250, and a broad assortment of other applications such as a third-party application 1252. The applications 1218 are programs that execute functions defined in the programs. Various programming languages can be employed to create one or more of the applications 1218, structured in a variety of manners, such as object-oriented programming languages (e.g., Objective-C, Java, or C++) or procedural programming languages (e.g., C or assembly language). In a specific example, the third-party application 1252 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1252 can invoke the API calls 1220 provided by the operating system 1212 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1 is a system comprising: at least one processor; at least one memory component storing instructions that, when executed by the at least one processor, cause the at least one processor to perform operations comprising: providing access to a content collection of a first user of an application, the first user being associated with a first device; storing, based on the providing, a respective timestamp for each view of the content collection by second users of the application, the second users being associated with second devices; receiving, from the first device, a request to display an indication of each view of the content collection by the second users; determining, in response to receiving the request, whether the first user has a paid subscription with respect to the application; and providing, on the first device and upon determining that the first user has a paid subscription, display of the views with timestamp information based on the respective timestamp for each view of the content collection.

In Example 2, the subject matter of Example 1 includes, the operations further comprising: providing, on the first device and upon determining that the first user does not have a paid subscription, display of the views while omitting the timestamp information for each view of the content collection.

In Example 3, the subject matter of Examples 1-2 includes, wherein providing display of the views with the timestamp information comprises: determining, for a first timestamp of the respective timestamps, an amount of time elapsed between the first timestamp and a current time; and providing, when the amount of time is below a first time threshold, display of the timestamp information of the first timestamp according to a first format.

In Example 4, the subject matter of Example 3 includes, wherein providing display of the views with the timestamp information further comprises: providing, when the amount of time meets the first time threshold, display of the timestamp information of the first timestamp according to a second format.

In Example 5, the subject matter of Examples 3-4 includes, wherein providing display of the views with the timestamp information further comprises: providing, when the amount of time is below a second time threshold which is less than the first time threshold, display of the timestamp information of the first timestamp according to a third format.

In Example 6, the subject matter of Examples 1-5 includes, the operations further comprising: providing, on the first device, display of an interface element which is user-selectable to enable display of the timestamp information; and receiving, via the interface element, user input selecting to enable display of the timestamp information, wherein providing display of the views with the timestamp information is based on receiving the first user input.

In Example 7, the subject matter of Examples 1-6 includes, the operations further comprising: providing, on the first device and upon determining that the first user does not have a paid subscription, a user-selectable element for the first user to enroll for the paid subscription with respect to the application.

Example 8 is a computer-implemented method, comprising; providing access to a content collection of a first user of an application, the first user being associated with a first device; storing, based on the providing, a respective timestamp for each view of the content collection by second users of the application, the second users being associated with second devices; receiving, from the first device, a request to display an indication of each view of the content collection by the second users; determining, in response to receiving the request, whether the first user has a paid subscription with respect to the application; and providing, on the first device and upon determining that the first user has a paid subscription, display of the views with timestamp information based on the respective timestamp for each view of the content collection.

In Example 9, the subject matter of Example 8 includes, providing, on the first device and upon determining that the first user does not have a paid subscription, display of the views while omitting the timestamp information for each view of the content collection.

In Example 10, the subject matter of Examples 8-9 includes, wherein providing display of the views with the timestamp information comprises: determining, for a first timestamp of the respective timestamps, an amount of time elapsed between the first timestamp and a current time; and providing, when the amount of time is below a first time threshold, display of the timestamp information of the first timestamp according to a first format.

In Example 11, the subject matter of Example 10 includes, wherein providing display of the views with the timestamp information further comprises: providing, when the amount of time meets the first time threshold, display of the timestamp information of the first timestamp according to a second format.

In Example 12, the subject matter of Examples 10-11 includes, wherein providing display of the views with the timestamp information further comprises: providing, when the amount of time is below a second time threshold which is less than the first time threshold, display of the timestamp information of the first timestamp according to a third format.

In Example 13, the subject matter of Examples 8-12 includes, providing, on the first device, display of an interface element which is user-selectable to enable display of the timestamp information; and receiving, via the interface element, user input selecting to enable display of the timestamp information, wherein providing display of the views with the timestamp information is based on receiving the first user input.

In Example 14, the subject matter of Examples 8-13 includes, providing, on the first device and upon determining that the first user does not have a paid subscription, a user-selectable element for the first user to enroll for the paid subscription with respect to the application.

Example 15 is a non-transitory computer-readable storage medium storing instructions that, when executed by at least one processor, cause the at least one processor to perform operations comprising; providing access to a content collection of a first user of an application, the first user being associated with a first device; storing, based on the providing, a respective timestamp for each view of the content collection by second users of the application, the second users being associated with second devices; receiving, from the first device, a request to display an indication of each view of the content collection by the second users; determining, in response to receiving the request, whether the first user has a paid subscription with respect to the application; and providing, on the first device and upon determining that the first user has a paid subscription, display of the views with timestamp information based on the respective timestamp for each view of the content collection.

In Example 16, the subject matter of Example 15 includes, the operations further comprising: providing, on the first device and upon determining that the first user does not have a paid subscription, display of the views while omitting the timestamp information for each view of the content collection.

In Example 17, the subject matter of Examples 15-16 includes, wherein providing display of the views with the timestamp information comprises: determining, for a first timestamp of the respective timestamps, an amount of time elapsed between the first timestamp and a current time; and providing, when the amount of time is below a first time threshold, display of the timestamp information of the first timestamp according to a first format.

In Example 18, the subject matter of Example 17 includes, wherein providing display of the views with the timestamp information further comprises: providing, when the amount of time meets the first time threshold, display of the timestamp information of the first timestamp according to a second format.

In Example 19, the subject matter of Examples 17-18 includes, wherein providing display of the views with the timestamp information further comprises: providing, when the amount of time is below a second time threshold which is less than the first time threshold, display of the timestamp information of the first timestamp according to a third format.

In Example 20, the subject matter of Examples 15-19 includes, the operations further comprising: providing, on the first device, display of an interface element which is user-selectable to enable display of the timestamp information; and receiving, via the interface element, user input selecting to enable display of the timestamp information, wherein providing display of the views with the timestamp information is based on receiving the first user input.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
providing access to a content collection of a first user of an application, the first user being associated with a first device;
storing, based on the providing, a respective timestamp for each view of the content collection by second users of the application, the second users being associated with second devices;
receiving, from the first device, a request to display an indication of each view of the content collection by the second users;
determining, in response to receiving the request, whether the first user has a paid subscription with respect to the application; and
providing, on the first device and upon determining that the first user has a paid subscription, display of the views with timestamp information based on the respective timestamp for each view of the content collection.

2. The system of claim 1, the operations further comprising:
providing, on the first device and upon determining that the first user does not have a paid subscription, display of the views while omitting the timestamp information for each view of the content collection.

3. The system of claim 1, wherein providing display of the views with the timestamp information comprises:
determining, for a first timestamp of the respective timestamps, an amount of time elapsed between the first timestamp and a current time; and
providing, when the amount of time is below a first time threshold, display of the timestamp information of the first timestamp according to a first format.

4. The system of claim 3, wherein providing display of the views with the timestamp information further comprises:
providing, when the amount of time meets the first time threshold, display of the timestamp information of the first timestamp according to a second format.

5. The system of claim 3, wherein providing display of the views with the timestamp information further comprises:
providing, when the amount of time is below a second time threshold which is less than the first time threshold, display of the timestamp information of the first timestamp according to a third format.

6. The system of claim 1, the operations further comprising:
providing, on the first device, display of an interface element which is user-selectable to enable display of the timestamp information; and
receiving, via the interface element, user input selecting to enable display of the timestamp information,
wherein providing display of the views with the timestamp information is based on receiving the first user input.

7. The system of claim 1, the operations further comprising:
providing, on the first device and upon determining that the first user does not have a paid subscription, a user-selectable element for the first user to enroll for the paid subscription with respect to the application.

8. A computer-implemented method, comprising;
providing access to a content collection of a first user of an application, the first user being associated with a first device;
storing, based on the providing, a respective timestamp for each view of the content collection by second users of the application, the second users being associated with second devices;
receiving, from the first device, a request to display an indication of each view of the content collection by the second users;
determining, in response to receiving the request, whether the first user has a paid subscription with respect to the application; and
providing, on the first device and upon determining that the first user has a paid subscription, display of the views with timestamp information based on the respective timestamp for each view of the content collection.

9. The computer-implemented method of claim 8, further comprising:
providing, on the first device and upon determining that the first user does not have a paid subscription, display of the views while omitting the timestamp information for each view of the content collection.

10. The computer-implemented method of claim 8, wherein providing display of the views with the timestamp information comprises:
determining, for a first timestamp of the respective timestamps, an amount of time elapsed between the first timestamp and a current time; and
providing, when the amount of time is below a first time threshold, display of the timestamp information of the first timestamp according to a first format.

11. The computer-implemented method of claim 10, wherein providing display of the views with the timestamp information further comprises:
providing, when the amount of time meets the first time threshold, display of the timestamp information of the first timestamp according to a second format.

12. The computer-implemented method of claim 10, wherein providing display of the views with the timestamp information further comprises:
providing, when the amount of time is below a second time threshold which is less than the first time threshold, display of the timestamp information of the first timestamp according to a third format.

13. The computer-implemented method of claim 8, further comprising:
providing, on the first device, display of an interface element which is user-selectable to enable display of the timestamp information; and
receiving, via the interface element, user input selecting to enable display of the timestamp information,
wherein providing display of the views with the timestamp information is based on receiving the first user input.

14. The computer-implemented method of claim 8, further comprising:
providing, on the first device and upon determining that the first user does not have a paid subscription, a user-selectable element for the first user to enroll for the paid subscription with respect to the application.

15. A non-transitory computer-readable storage medium storing instructions that, when executed by at least one processor, cause the at least one processor to perform operations comprising;
providing access to a content collection of a first user of an application, the first user being associated with a first device;
storing, based on the providing, a respective timestamp for each view of the content collection by second users of the application, the second users being associated with second devices;
receiving, from the first device, a request to display an indication of each view of the content collection by the second users;
determining, in response to receiving the request, whether the first user has a paid subscription with respect to the application; and
providing, on the first device and upon determining that the first user has a paid subscription, display of the views with timestamp information based on the respective timestamp for each view of the content collection.

16. The non-transitory computer-readable storage medium of claim 15, the operations further comprising:
providing, on the first device and upon determining that the first user does not have a paid subscription, display of the views while omitting the timestamp information for each view of the content collection.

17. The non-transitory computer-readable storage medium of claim 15, wherein providing display of the views with the timestamp information comprises:
determining, for a first timestamp of the respective timestamps, an amount of time elapsed between the first timestamp and a current time; and
providing, when the amount of time is below a first time threshold, display of the timestamp information of the first timestamp according to a first format.

18. The non-transitory computer-readable storage medium of claim 17, wherein providing display of the views with the timestamp information further comprises:
providing, when the amount of time meets the first time threshold, display of the timestamp information of the first timestamp according to a second format.

19. The non-transitory computer-readable storage medium of claim 17, wherein providing display of the views with the timestamp information further comprises:
providing, when the amount of time is below a second time threshold which is less than the first time threshold, display of the timestamp information of the first timestamp according to a third format.

20. The non-transitory computer-readable storage medium of claim 15, the operations further comprising:
providing, on the first device, display of an interface element which is user-selectable to enable display of the timestamp information; and
receiving, via the interface element, user input selecting to enable display of the timestamp information,
wherein providing display of the views with the timestamp information is based on receiving the first user input.
